(19) United States
(12) Patent Application Publication
(10) Pub. No.: US 2013/0138930 A1
(43) Pub. Date: May 30, 2013

(54) COMPUTER SYSTEMS AND METHODS FOR REGISTER-BASED MESSAGE PASSING

(71) Applicant: PETER J. WILSON, Leander, TX (US)

(72) Inventor: PETER J. WILSON, Leander, TX (US)

(21) Appl. No.: 13/307,303

(22) Filed: Nov. 30, 2011

(51) Int. Cl. G06F 9/30; G06F 9/44

(52) U.S. Cl. 712/225; 712/E09.023; 712/E09.034

(57) ABSTRACT

Systems and methods are disclosed that include a plurality of processing units having a plurality of register file entries. Control logic identifies a first register entry as including a message address in response to receiving a first instruction. The control logic further identifies a second register entry to receive messages in response to receiving a second instruction.

### BACKGROUND

1. Field

This disclosure relates generally to computer processor architecture, and more specifically, to register-based message passing in multi-core processors.

2. Related Art

Multiprocessor computer systems have been known for many years, but their architecture, in particular how software running on one processor interacts with software running on another processor have generally made use of expensive and inefficient mechanisms such as shared memory and interprocessor interrupts. Thus facilities for cost-effective and efficient inter-program communication are rare. Further, shared-bus systems limited the maximum number of processors to a dozen or two (for cache-coherent SMPs), although ‘clusters’ could get much larger at the expense of having the expected cache behavior be managed explicitly by software instead of hardware.

Current VLSI technology is pushing system architectures to embrace an increasingly large number of processing units (or other intelligent agents) on a single chip. This means that increasingly software running on or controlling agents will need to efficiently communicate across processing units and agents. Current practice such as shared memory, interprocessor interrupts, etc., is slow and does not scale well, in addition to often requiring expensive and also difficult to scale cache-coherent shared memory.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 illustrates, in block diagram form, a portion of a pipelineable data processing system in accordance with an embodiment of the present invention.

FIG. 2 illustrates in block diagram form an exemplary processor of the data processing system of FIG. 1 in accordance with one embodiment of the present invention.

FIG. 3 illustrates in block diagram form an exemplary processor of the data processing system of FIG. 1 in accordance with one embodiment of the present invention.

FIG. 4 illustrates in block diagram form an exemplary processor of the data processing system of FIG. 1 in accordance with one embodiment of the present invention.

### DETAILED DESCRIPTION

Embodiments of systems and methods disclosed herein provide inter-machine (and inter-process) communications between multiple processing units that has low-latency and low power requirements, is simple to implement in hardware, and does not rely on consistency between data stored in cache memory. In some embodiments, techniques disclosed herein enable multiple processing units to work together to execute single-thread programs, giving the effect of a machine capable of issuing multiple instructions with much simpler hardware architecture than systems currently known.

In some embodiments, new instructions for message sending, message receiving and managing messages are provided. The instructions can be added to an existing architecture, or can form the basis of a new architecture. Registers can have new indicators, such as sender, receiver, and empty to communicate messages between processing units. The destination of a message can be specified as an address in a register in the sending machine, and the message can be received in a register in the destination machine. Further aspects of embodiments disclosed herein include defining registers as sending and receiving registers, the sending and receiving of messages, the ability to use a processing unit as a message-driven function unit (rather than as an autonomous instruction-executing processor), broadcasting messages to multiple destinations, efficiently performing a rendezvous action awaiting a number of messages which will arrive in an unknown order, sending messages between agents other than processing units (such as DMA engines and accelerators), and taking advantage of multithreading capabilities in the processing units or agents.

Various embodiments described herein relate to a simple reduced instruction set computer (RISC) architecture that has 32 bit instructions, and 64 32-bit wide general purpose registers. To simplify the description, the instruction set is limited to integer operations, and provides the usual selection of arithmetic and logical instructions, branches, branch-and-link, conditional branches, comparisons and memory access operations. A first instruction format provides an encoding for three-operand operations where all the operands are registers. Examples include operations such as add, subtract, load (read memory) and so forth. Another instruction format provides an encoding for the same operations, but with the second source operand being a literal value provided in the instruction in place of the second register. A third instruction format provides a format for specifying an operation with one register and one literal operand, for operations such as comparing a register and branching conditionally, or branching to an address specified by the contents of a register plus an offset. A final format provides a large offset for branches with no register specifier. Other processor architectures, instruction sets, and instruction formats can be used, however.

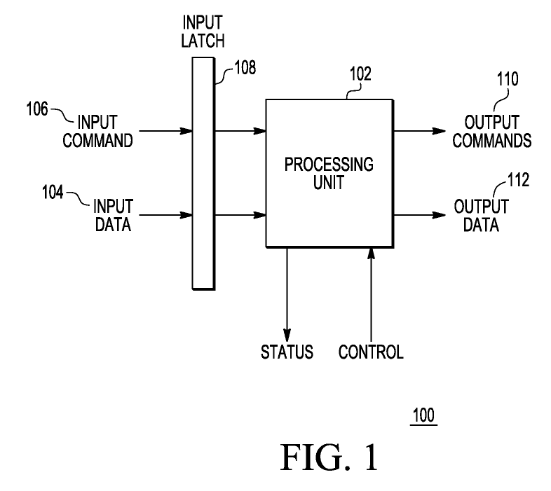

FIG. 1 illustrates, in block diagram form, a portion of a pipelineable data processing system 100 in accordance with an embodiment of the present invention including processing unit 102 which is responsive to input data 104 and input commands 106 received through input latch 108. Processing unit 102 generates output commands 110 and output data 112 which are used to interface with other circuits. The detailed behavior of processing unit 102 may be controlled via information sent on one or more control lines and may provide status via one or more status lines. System 100 may also use a Memory Management Unit, or MMU (not shown), to provide mapping between the logical addresses used by software and a physical address. System 100 may further use a Message Management Unit (MeMU) (not shown), which performs a function equivalent to the MMU but for message addresses.

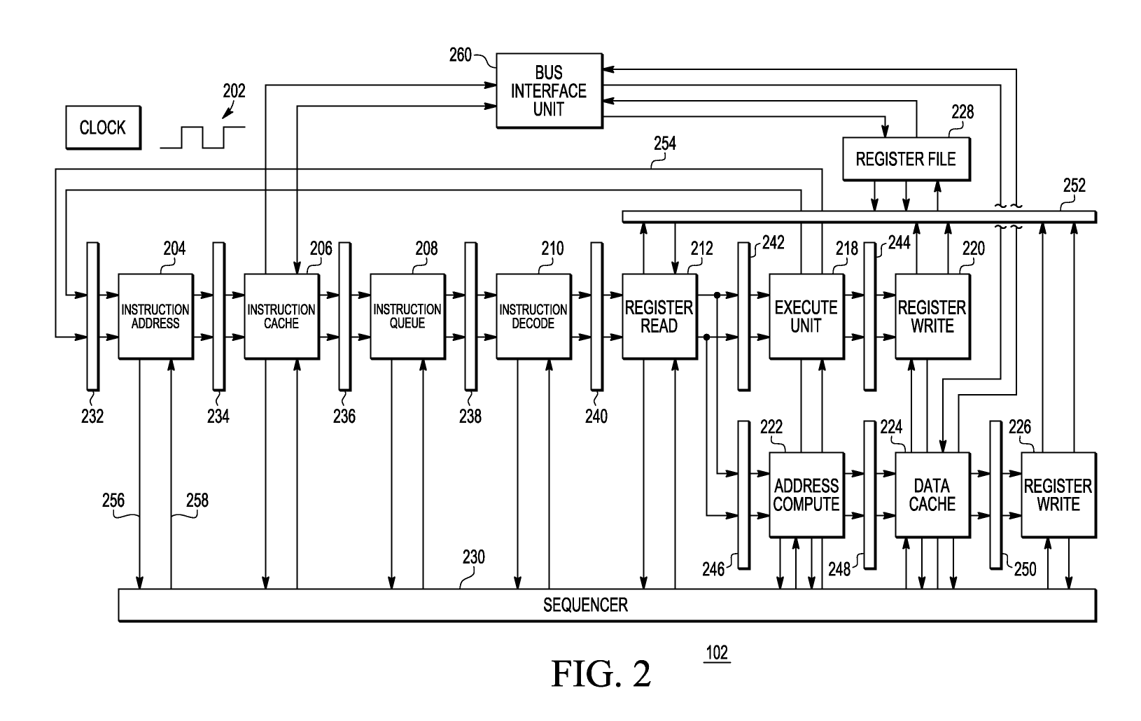

FIG. 2 illustrates in block diagram form further detail of an embodiment of processing unit 102 of the data processing system of FIG. 1. For the purposes of example, a canonical pipelined microprocessor is described herein, however the claims are not intended to be limited to a particular processing system architecture and one of ordinary skill in the art will appreciate that other microprocessor configurations can be used as well. A canonical pipelined microprocessor includes a number of different processing units 102, each generally of the form depicted in FIG. 1. In operation, each processing unit 102 reads data and performs various appropriate internal operations in response to a clock signal 202. Other configurations that are self-timed are also possible.

Referring to FIG. 2, processing unit 102 generally includes instruction address block 204, an instruction cache 206, an instruction queue block 208, an instruction decode block 210, a register read block 212, an execute unit 218, a register write block 220, an address compute unit 222, a data cache 224, a second register write block 226, a register file 228, and a sequencer 230, as well as a plurality of input latches 232-252 associated with each functional block. Also included is a branch path 254 and control and status signals for each processing unit 102. For simplicity only one pair of status and control signals are represented by designators 256, 258. Again, other configurations for processing unit 102 can be used.

Processing unit 102 generally operates in the following manner. Instruction block 204 stores a value representing the address of the next instruction to be executed. This value is presented to input latch 234 of the instruction cache 206 at every clock signal, prior to the rising edge of the clock. The instruction cache 206 then uses this address to read the corresponding instruction from within itself. The instruction cache 206 then presents the address and instruction to the instruction queue block 208 before the next rising clock edge via latch 236. On the rising clock edge, the instruction queue block 208 adds the address and the instruction to the end of its internal queue and removes the instruction and address at the bottom of its queue before the next rising edge of the clock, providing both the instruction and address through latch 238 to the instruction decode block 210. The instruction decode block 210 reads the instruction and address from its input latch 238 at the rising edge of the clock. The instruction decode block 210 examines the instruction and generates output data containing (depending on the instruction) specifications of the registers to be used in the execution of the instruction, any data value from the instruction, and a recoding of the operation requested by the instruction.

The register read block 212 reads the incoming data from the instruction decode block 210 at the rising edge of the clock and causes, through latch 252, the register file block 228 to read the values of the specified source registers. The register read block 212 reads these values from the register file 228 in the first half of the clock period and provides them both to the address compute unit 222 and the execute unit 218 before the clock's next rising edge. Both the address compute unit 222 and the execute unit 218 read the data from their input latches 246, 242 respectively, before the rising edge of the clock. One portion of the data specifies the operation required, and either the execute unit 218 or the address compute unit 222 will obey. The execute unit 218 that does not obey produces no output.

If the execute unit 218 is required to act, execute unit 218 will perform the appropriate computation on the values provided and will produce an output before the rising edge of the next clock. This output is read at the rising edge by the register write block 220 which receives a destination register specifier and a value to be written thereto.

If the operation requested requires the address compute unit 222 to act, the execute unit 218 performs no function, and the address compute unit performs appropriate arithmetic functions, such as adding two values, and provides the result to the data cache 224 along with the requested operation before the next rising edge of the clock. The data cache 224 reads this information from input latch 248 at the rising edge of the clock, and performs appropriate action on its internal memory, within the clock timeframe. If the operation requested is a load operation, the value read from the data memory 224 is presented to the second write register 226, before the rising edge of the clock. On the rising edge of the clock, the second write register 226 captures the register specifier and value to be written, and forces the register file 228 to write to that specified register. The sequencer 230 has knowledge of how much time the various execution units require to complete the tasks they have been given and can arrange for one or more processing units 102 in the microprocessor pipeline to freeze (for example when a multi-cycle instruction writes a register used as a source in the next instruction).

The sequencer 230 communicates with components of processing unit 102 by reading the status signal 256 and providing the control signal 258. Some instructions, such as multiplication instructions often take multiple cycles.

In addition to the above description, the processing unit 102 can utilize branch instructions, which may cause the microprocessor to execute an instruction other than the next sequential instruction. Branches are further handled by branch path 254 from the execute unit 218 to the instruction address block 204. When a branch must be taken, the execute unit 218 provides the desired address and signals to the sequencer 230. The instruction address block 204 changes its stored internal value to the new address and provides it to the instruction memory 206. The sequencer 230 tracks the progress of the new instruction down the pipeline, ensuring that no registers are changed by instructions in the pipeline between the branch instruction and the new instruction.

The instruction cache 206 and data cache 224 may also be implemented as simple memories or as a hierarchy of caches if desired. Memory management units (MMUs) (not shown) may also be provided to operate in parallel with the caches 206, 224 and provide address translation and protection mechanisms.

When the instruction cache 206 or data cache 224 do not contain the data requested then the sequencer 230 may cause them to signal the Bus Interface Unit (BIU) 260 through the appropriate cache. The BIU 260 intercedes between the processing 102 and the rest of the system 100 (FIG. 1), marshaling requests (such as a request to read a memory location or to write a memory location) to the rest of the system 100 and capturing and properly directing responses from the system to the processing unit 102.

Rather than using the sequencer 230 to have specific knowledge of how long an operation might take, it can be simpler to provide the registers in the register file 228 with a busy bit. A busy bit is set to a first value such as 1 if a register is not available for use, and is set to a second value such as 0 if the register is ready for use. When a multiple-cycle operation such as a multiply or a read from the data cache 224 occurs, the destination register in register file 228 has its busy bit set by the sequencer 230. Before allowing a register to be read, the Register Read stage 212 checks that all the registers to be used by an instruction have empty busy bits. If a register has a set busy bit, the sequencer 230 stalls that instruction at the register read stage, awaiting completion of a prior operation targeting the register or registers with busy bits. When all registers involved have zero busy bits, the instruction is allowed to continue, setting an appropriate busy bit if it is a multicycle operation.

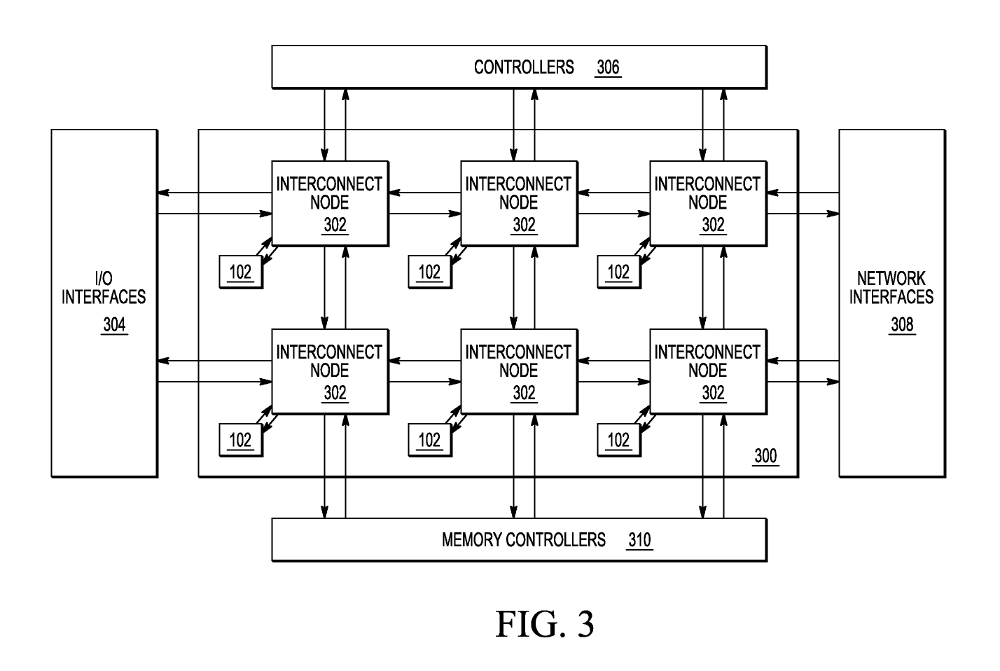

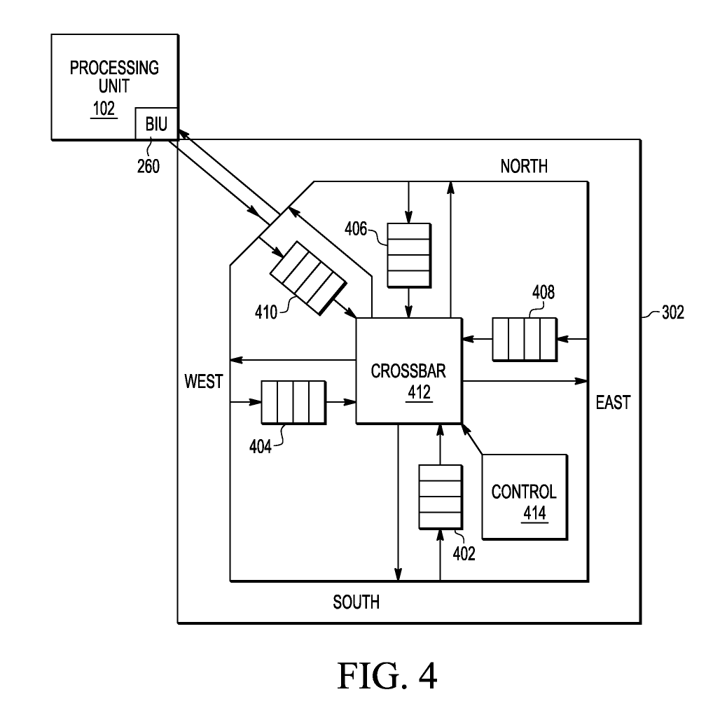

When a processing unit 102 is to be used in a system 100 of many interconnected processing units 102, a system interconnect other than a bus can be used. Often a mesh of interconnects is appropriate. Such a mesh 300 of interconnect nodes 302 is shown in FIG. 3 depicting an array of interconnect nodes 302 connected to other interconnect nodes 302 in respective north, south, east and west directions (Shown in further detail in FIG. 4). Interconnect node 302 can be associated with and configured to communicate with a respective processing unit 102. Interconnect nodes 302 can operate concurrently, and thus data transfers may be occurring on all of the interconnect nodes 302 simultaneously. Resources such as memory controllers 306, 310, I/O device interfaces 304, and network interfaces 308 may be configured to communicate with mesh 300.

A more detailed view of an embodiment of processing unit 102 and interconnect 302 is depicted in FIG. 4 with BIU 260 of processing unit 102 coupled to communicate bidirectionally with interconnect 302. Interconnect node 302 can include input buffers 402-410 to temporarily hold messages from other interconnect nodes 302 and processing unit 102 when crossbar switch 412 cannot immediately handle the messages. The behavior of the crossbar switch 412 can be controlled in accordance with suitable network protocol logic in control block 414. Messages can move from one interconnect node 302 to another, for example from the West out to the North, by passing through the crossbar switch 412 until the messages reach their destination processing unit 102. Processing unit 102 may receive messages from the crossbar switch 412, and send messages to the crossbar switch 412, via a respective BIU 260.

Data and other information passed between processing units 102 may be written into respective register files 228 (FIG. 2) via connections from the BIU 260 to the register file 228 and appropriately modifying the sequencer 230. Multiple interfaces between BIU 260 and one or more interconnect nodes 302 can be implemented for a single processing unit 102 to support multiple meshes 300 (FIG. 3) operating concurrently.

In some embodiments, there are three instruction formats; one format provides an encoding for three-operand operations where all the operands are registers; examples include operations such as add, subtract, load (read memory) and so forth. Another instruction format provides an encoding for the same operations, but with the second source operand being a literal value provided in the instruction in place of the second register. A third instruction format provides a format for specifying an operation with one register and one literal operand, for operations such as comparing a register and branching conditionally, or branching to an address specified by the contents of a register plus an offset. A fourth instruction format provides a large offset for branches with no register specifier. Other instruction formats can be used in addition to or instead of the instruction formats described herein.

Tables 1-5 below show embodiments of the four instruction formats, instruction mnemonics, and the effect of executing each instruction. Note that only a minimal set of operations is shown here, and the simple encodings are for provided as an example. Other instructions and instructions encodings may be used.

TABLE 1
Four Instruction Formats

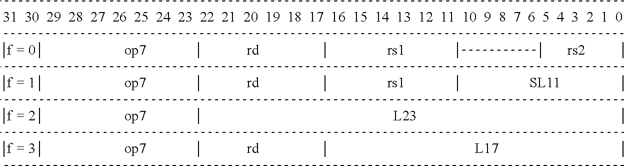

TABLE 2
Format 0 instructions: Register-operand operations

| Op7 | | |
|---|---|---|
| Values | mnemonic | operation |
| 0 | add r1,r2, r3 | r1 := r2 + r3 (with carry and overflow) |
| 1 | sub r1, r2, r3 | r1 := r2 − r3 (with carry and overflow) |
| 2 | mul r1, r2, r3 | r1 := r2 * r3 (with carry and overflow) |
| 3 | div r1, r2, r3 | r1 := r2/r3 (with carry and overflow) |
| 4 | rem r1, r2, r3 | r1 := r2 % r3 (with carry and overflow) |
| 5 | and r1, r2, r3 | r1 := r2 & r3 |
| 6 | or r1, r2, r3 | r1 := r2\|r3 |
| 7 | xor r1, r2, r3 | r1 := r2 \hat{ } r3 |
| 8 | Ishl r1, r2, r3 | r1 := r2 << r3 (with carry and overflow) |
| 9 | ashl r1, r2, r3 | r1 := r2 << r3 |
| 10 | Ishr r1, r2, r3 | r1 := r2 >> r3 |
| 11 | ashr r1, r2, r3 | r1 := r2 >> r3 (with sign propagation) |
| 12 | cmp r1, r2, r3 | r1 := r2 ? r3 (set r1 = -1, 0, 1 as |
| | | r2 == r3, >= or < |
| 13 | Id8 r1, r2, r3 | r1 := memory8[r2 + r3] load a byte from a |
| | | byte address in memory |
| 14 | Id16 r1, r2, r3 | r1 := memory16[r2 + r3] load two bytes |
| | | from a 2-byte address in memory |
| 15 | Id32 r1, r2, r3 | r1 := memory32[r2 + r3] load four bytes |
| | | from a word address in memory |
| 16 | st8 r1, r2, r3 | memory8[r2 + r3] := r1 & 0xff write a byte |
| | | to a byte address in memory |
| 17 | st16 r1, r2, r3 | memory16[r2 + r3] := r1 & 0xffff write two |
| | | bytes to a 2-byte address in memory |
| 18 | st32 r1, r2, r3 | memory32[r2 + r3] := r1 write a word to a |
| | | word address in memory |
| 19 | copy r1, r3 | r1 := r3 |
| 20 | ** reserved ** | |

TABLE 3
Format 1 instructions: Register-literal operations

| Op7 Values | mnemonic | operation |
|---|---|---|
| 0 | addi r1, r2, SL11 | r1 := r2 + SL11 (with carry and overflow) |
| 1 | subi r1, r2, SL11 | r1 := r2 − SL11 (with carry and overflow) |
| 2 | muli r1, r2, SL11 | r1 := r2 * SL11 (with carry and overflow) |
| 3 | divi r1, r2, SL11 | r1 := r2/SL11 (with carry and overflow) |
| 4 | remi r1, r2, SL11 | r1 := r2 % SL11 (with carry and overflow) |
| 5 | andi r1, r2, L11 | r1 := r2 & L11 |
| 6 | ori r1, r2, L11 | r1 := r2\|L11 |
| 7 | xori r1, r2, L11 | r1 := r2 \hat{ } L11 |
| 8 | Ishli r1, r2, SL11 | r1 := r2 << SL11 (with carry and overflow) |
| 9 | ashli r1, r2, SL11 | r1 := r2 << SL11 |
| 10 | Ishri r1, r2, SL11 | r1 := r2 >> SL11 |
| 11 | ashri r1, r2, SL11 | r1 := r2 >> SL11 (with sign propagation) |
| 12 | cmpi r1, r2, SL11 | r1 := r2 ? SL11 (set r1 = −1, 0, 1 as r2 == SL11, |
| | | >= or < |
| 13 | Id8i r1, r2, SL11 | r1 := memory8[ r2 + SL11] load a byte from a byte |
| | | address in memory |
| 14 | Id16i r1, r2, SL11 | r1 := memory16[r2 + SL11] load two bytes from a 2- |
| | | byte address in memory |
| 15 | Id32i r1, r2,SL11 | r1 := memory32[r2 + SL11] load four bytes from a |
| | | word address in memory |
| 16 | st8i r1, r2, SL11 | memory8[r2 + SL11] := r1 & 0xff write a byte to a |
| | | byte address in memory |
| 17 | st16i r1, r2, SL11 | memory16[r2 + SL11] := r1 & 0xffffwrite two bytes to |
| | | a 2-byte address in memory |
| 18 | st32i r1, r2,SL11 | memory32[r2 + SL11] := r1 write a word to a word |
| | | address in memory |
| 19 | copyi r1, SL11 | r1 := SL11 |
| 20 | ** reserved ** | |

TABLE 4
Format 2 instructions: Register-operand operations

| Op7 Values | mnemonic | operation |
|---|---|---|
| 0 | b L23 | jump to [r0 + SL23] |
| 1 | bl L23 | r1 = r0; jump to [r0 + SL23] |
| 2 | ba L23 | jump to L23 |
| 3 | **reserved** | |

TABLE 5
Format 3 instructions: Register-operand operations

| Op7 Values | mnemonic | operation |
|---|---|---|
| 0 | bl r1, SL17 | r1 = r0; jump to [r0 + SL17] |
| 1 | bgtz r1, SL17 | if r1 >0, jump to [r0 + SL17] |
| 2 | bltz r1, SL17 | if r1 <0, jump to [r0 + SL17] |
| 3 | beqz r1, SL17 | if r1 == 0, jump to [r0 + SL17] |
| 4 | bnez r1, SL17 | if r1 ! = 0, jump to [r0 + SL17] |
| 5 | bgez r1, SL17 | if r1 >= 0, jump to [r0 + SL17] |
| 6 | blez r1, SL17 | if r1 <= 0, jump to [r0 + SL17] |
| 7 | ret r1, SL17 | jump to [r1 + SL17] |
| 8 | decgtz r1, SL17 | decrement r1, and branch to |
| | | [r0 + SL17] if > 0 |
| 9 | **reserved** | |

Table 6 describes an example of the functions of registers that can be used in register file 228 (FIG. 2). R0 can be a status register, holding a bitvector representing carry, overflow, and the results of comparisons. R1 can be used as the processor's “program counter (PC)”, or “instruction pointer” that holds the address of the currently-executing instruction as a word address. R2 can be the default link register, holding the (word) return address created by execution of a branch-and-link instruction (bl). Registers 3-63 can be used for general purposes.

TABLE 6
General-Purpose Registers

| Op7 Values | mnemonic | operation |
|---|---|---|
| 0 | SR | Status register-holds results of compares, |
| | | carries and overflows |
| 1 | PC | Holds the address of the current instruction |
| 2 | LR | Default Link register |
| 3-63 | R3 . . . R63 | General-purpose registers |

A specific set of instructions can be used to pass messages between processing units 102 in system 100. The messages are delivered into a specified register in the receiving processing unit 102. In some embodiments, a message will not be sent until the receiver can receive the message. Program execution on the sender can stall until the message can be sent. The receiver can stall when reading the receiver register until the message arrives.

In the absence of messages to/from the processing unit 102 associated with a particular interconnect node 302, interconnect node 302 can capture and pass along messages to other interconnect nodes 302 on their way to a particular destination processing unit 102. The details of the routing operation can vary with differing interconnect protocols.

In some embodiments, four instructions are used to identify registers as sending or receiving registers. The first instruction is markforsend, which identifies a specific register in a processing unit 102 as containing the message address of a register in a processing unit 102. The second instruction is clearforsend, which reverts a specified register to normal use, so it is no longer identified as containing a message address of a register in a processing unit 102.

The third instruction is markforreceive, which identifies a specific register in a processing unit 102 as one which is to receive messages. The fourth instruction is clearforreceive, which removes the identification of that register as being for receiving messages. Other suitable instructions and/or names for the instructions can be used.

In some embodiments, the registers used for message passing can have data bits or fields, also referred to as “tags”. These tags can be used to describe the desired behavior of the register. In some implementations, three bits are used: a first bit indicates sender; a second bit indicates receiver, and a third bit indicates a message is available. The bits for a register rn can be referred to in the instruction specifications as rn[sender], rn[receiver] and rn [message].

A register in ordinary use in a processing unit 102 will have all of the message passing bits clear. The markforsend instruction can be implemented to set the sender bit of a specified register. The clearforsend instruction can be implemented to clear the sender bit. The markforreceive instruction can set the receiver bit for a specific register, and also clear the message bit. The clearforreceive instruction can clear the receiver bit of the specified register. Examples of encodings for the message-passing instructions and their actions are shown in Tables 7 and 8.

TABLE 7
Basic Message-passing instructions (format 0).
Register-operand operations

| Op7 | | |
|---|---|---|
| Values | mnemonic | operation |
| 32 | markforsend r1, r2 | r1[sender] := TRUE; |
| | | r1[receiver] := FALSE; r1:= r2 |
| 33 | clearforsend r1 | r1[sender] := FALSE |
| 34 | markforreceive r1 | r1[receiver] := TRUE; |
| | | r1[message] = FALSE; |
| | | r1[sender] := FALSE |
| 35 | clearforreceive r1 | r1[receiver] := FALSE |
| 36 | **reserved** | |

TABLE 8
Basic Message-passing instructions (format 1).
Register-literal operations

| Op7 | | |
|---|---|---|
| Values | mnemonic | operation |
| 32 | markforsend r1, L11 | r1[sender] := TRUE; |
| | | r1[receiver] := FALSE; r1 := L11 |
| 33 | clearforsend r1 | r1[sender] := FALSE |
| 34 | markforreceive r1 | r1[receiver] := TRUE; |
| | | r1[message] = FALSE; |
| | | r1[sender] := FALSE |
| 35 | clearforreceive r1 | r1[receiver] := FALSE |
| 36 | ** reserved ** | |

When any of the basic architecture instructions which specify a register as source or destination are executed, their execution behavior is different. A high-level description of ordinary basic-architecture instructions is as follows:

// instruction fetch-and-execute loop for the basic architecture
execute_instructions( ) {
forever {

instruction = fetch (PC++); // fetch the instruction and increment the
instruction pointer
switch (instruction.format) {

case 0:

decode instruction −> operation, rd, rs1, rs2
switch (operation) {

case add: rd[value] := rs1[value] + rs2[value]; break
case.... // all the other operations work equivalently
...
}

}

break;
case 1:

// other instruction formats managed similarly

...
}

}
}

The behavior when the message-passing architecture is added is as follows:

instruction fetch-and-execute loop
execute_instructions( ) {
forever {

send_messages( ); // send any messages awaiting sending
accept_messages( ); // receive any messages, placing them into
appropriate registers
instruction = fetch (PC++); // fetch the instruction and increment the
instruction pointer
switch (format) {

case 0:

```
decode instruction −> operation, rd, rs1, rs2
// if either source register is marked for receive, but does
// not yet have its message, stall
if (((rs1[receiver] == TRUE) && (rs1[message ==
FALSE)) | |
  ((rs2[receiver] == TRUE) && (rs2[message ==
  FALSE))) {
```

| | |
|---|---|
| PC--; | // adjust instruction pointer so we retry this |

//instruction next time

break;
}

// if the destination is not a sender, we can proceed
// if it is a sender, and we can send the message, we can
proceed
if (((rd[sender] == TRUE) && cansend( )) | |
(rd[sender] == FALSE)) {

// yes, we can, so it is safe to proceed with the
operation
// either no messages, or all messages have been
received
switch (operation) {

case add: result := rs1[value] + rs2[value]; break
case.... // all the other operations work
equivalently
}

if (rd[sender]) {

sendmessage(rd[value],result);
}

else {

rd[value] := result;
}

rs1[message] = FALSE;
rs2[message] = FALSE;
}

else {

| // otherwise, we have to stall | |
|---|---|
| PC--; | // adjust instruction pointer so we retry this |

// instruction next time

break;
}

break;

case 1:

// other instruction formats managed similarly

...
}

}

}

For every message passing instruction executed on a processing unit 102, the processing unit 102 can send any messages stored for sending from previous instructions, and can accept any messages from the interconnect node 302, writing the values into the appropriate registers and marking the registers as containing messages. The next instruction can then be fetched and executed. The message-passing instructions can be executed sequentially, in parallel, and/or in a pipelined manner.

A message-passing instruction that specifies a register as a source operand can, before using the value in that register as an operand, determine whether the register is marked for receive and has a message. If the register is marked for receive and has a message, the value in the register may be used as an operand.

If the destination register is marked for sending, then the result of the operation is not written into that register, but can be sent via the interconnect node 302 to the requesting processing unit 102 and register specified by the value in the destination register.

If a message-passing instruction has all operands available and can send (if needed) then the message-passing instruction can be executed. Otherwise execution can be stalled by stopping the execution of the instruction and resetting the instruction pointer to point at the stalled instruction, so that execution is reattempted in a subsequent cycle.

Other techniques for handling message-passing instructions can be used, however. For example, the processing unit 102 might, on a first attempted execution of an instruction, note in the interconnect node 302 that an instruction is stalled awaiting the arrival of messages for certain registers, or stalled awaiting capacity in an output buffer 404-408, and not retry the instruction until these conditions are resolved.

Further, the action of receiving messages for subsequent instructions, and the sending of messages from previous instructions, may be overlapped with (done in parallel with) the execution of the instruction. Further, the execution of the instruction may be pipelined.

In some embodiments, messages can be routed by traversing mesh 300 vertically, then horizontally. Each interconnect node 302 knows its own coordinates in the x*y grid of interconnect nodes 302. A message arriving can have an address specified by (X, Y) as a coordinate in the grid.

Given that the address of an interconnect node 302 is (xI, yI, where I stands for Interconnect) and a message has a destination address of (xM, yM), the interconnect node 302 delivers the message to the respective processing unit 102 if (xM, yM) equals (xI, yI). Interconnect node 302 routes the message up if yM is greater than yI; down if yM is less than yI. If yI equals yM, then the message is routed left if xM is less than xI; and to the right if xM is greater than xI.

An example of a format for messages passed between processing units 102 is shown in Table 9 including fields for the destination (x,y) coordinates and the source (x, y) coordinates. The message format can also include a tag field, a receive register field, and the data of the message itself. The size of the address fields shown are appropriate for a system with a grid of 64×64 processing units 102 and 64 registers. The size of the message and of the fields can be varied to match the needs of different configurations. Various error correcting code, parity and check fields can be included in the message to ensure message and address integrity. A message can be sent if the processing unit 102 has spare message-sending buffer capacity, which can be checked by a cansend( ) instruction.

TABLE 9
Message Format

| 31 30 29 28 27 26 | 25 24 23 22 21 20 | 19 18 17 16 15 14 | 13 12 11 10 9 8 | 7 6 | 5 4 3 2 1 0 |
|---|---|---|---|---|---|
| dest X coord | dest Y coord | src X coord | src Y coord | tag | receivereg |

message data

Table 10 shows examples of values that can be used for the tag when passing messages between processing units 102. Table 11 shows examples of basic commands that can be used for register message passing. The tag value can describe what type of message is being sent. A normal message with a data payload can be formatted as in Table 9. A NAK message has no message data, and its receivereg field is empty. A command has the command in the receivereg field, and any data in the message data field.

Buffer 410 between interconnect node 302 and processing unit 102 can be used for messages to be delivered to the interconnect node 302. Another buffer (not shown) can be included between processing unit 102 and switch, for messages sent by interconnect node 302 to the processing unit 102.

TABLE 10
Message types and associated tag values

| Tag Value | Function | ReceiveReg Field | Payload Field |
|---|---|---|---|
| 0 | Data Message | Receive Register | Message data |
| 1 | Negative | — | — |
| | Acknowledgment (NAK) | | |
| 2 | command | command | optional data |
| 3 | counter | count | not present |

TABLE 11
Commands and associated field values

| Command | Function | Data Field |
|---|---|---|
| 0 | Reserve space request | Space requested |
| 1 | Buffer space allocated | Space allocated |
| 2 | Highwater mark hit | None |
| 3 | Lowwater mark hit | None |
| 4 | EndofStream | Receive register |
| 5 | Rendezvous | Bit number; Receive register |
| 6 | Reserved | |

If the interconnect node 302 cannot deliver a message to the processing unit 102 because a message buffer is full, interconnect node 302 can send a message back to the sender by creating a return message whose source and destination addresses are set so that destination is the source of the undeliverable message. The source of the return message is the undeliverable message's destination. The tag value can be set to a corresponding negative acknowledgment (NAK) value (e.g., “1” according to Table 10 herein) and provides the same data and receive register values as in the original message. In this way, the original sender does not need to keep a copy of data sent.

To minimize NAK messages, a sender can ask the receiver to reserve some amount of buffer space for its messages. Implementations will differ in how much space can be allocated, and for how many senders. A receiver can respond to a request to allocate space with a response indicating how much space has been allocated.

In some embodiments, a receiver can send an indication of how much buffer space is being used, by sending a highwatermark message when the buffer is close to “full”, and a lowwatermark message when the buffer is close to “empty”. Other suitable implementations can be used to indicate the availability of buffer space. A receiver can maintain a number of counters, one for each sender that it is tracking, and can increment the counter upon receipt of a message from the interconnect node 302, decrementing the counter on the processing unit 102 accepting a message. The counter value can be used to choose when to send the highwatermark and lowwatermark messages.

A sender-receiver pair with no specific buffer allocation can use the NAK tag for message control. A sender can choose to discontinue sending messages upon receiving a highwater mark message, and can resume upon receiving a lowwatermark. The processor can stall if the buffer between the processing unit 102 and the interconnect node 302 is full.

Many protocols that can be used in mesh 300 are known. Those intended specifically for use on a single integrated circuit are often known as “Networks on a Chip”. Example papers on such NOC protocols include: “Zooming in on NetworkonChip Architectures”, Israel Cidon and Idit Keidar; Conference: Colloquium on Structural Information & Communication Complexity—SIROCCO, 2009; “Designing and Implementation of a Network on Chip Router Base on Handshaking Communication Mechanism”, Seyyed Amir Asghari, Hossein Pedram, Mohammad Khademi, and Pooria Yaghini; World Applied Sciences Journal 6 (1): 88-93, 2009; ISSN 1818-4952; “On-Chip Multiprocessor Communication Network Design And Analysis”, a dissertation submitted to the department of electrical engineering and the committee on graduate studies of Stanford university in partial fulfillment of the requirements for the degree of doctor of philosophy; Terry Tao Ye, December 2003; and “On-Chip Interconnection Architecture Of The Tile Processor”, IEEE Micro 2007 0272-1732/07 G 2007 IEEE.

DMA Engines For Regular Memory Accesses

Some fragments of code distributed to a processing unit 102 for computations like this are simply reading or writing memory at locations separated by a constant amount. To save power, it would be preferable to use a mechanism that is more power-efficient than a processor, with its need to fetch and decode instructions. A well-known mechanism to perform regularly-spaced accesses to memory is the device called a DMA (for ‘Direct Memory Access’).

A DMA may have a small number of registers—a transfer address, a count, a stride and a transfer size. Generally, there is one set of registers for the source (where to read data from) and an equivalent set for the destination (where to write the data to). The transfer size will specify how much to read—a byte, a word, a cacheline etc. The transfer address specifies the current address to read from. The stride specifies how much to increment the address after each read or write. The count specifies how many transfers to perform.

In some embodiments, system 100 can include one or more DMA engines (not shown) that include at least one register file with one or more registers configured as a sending register or receiving register, similar to register file 228 (FIG. 2) in processing unit 102. A DMA may then be configured to read data from memory and send the value as a message to a processing unit 102, or to accept data in a receive register and write the data to memory when the data arrives. Using DMAs for message passing can use significantly less power than using processing unit 102 for message passing.

The code running on processing unit 102 can be replaced by DMA transfers. Each processing unit 102 can have one or more DMA engines associated with it. Controlling the DMA might be by reading or writing its registers, either as part of the register address space or as is traditional, as memory-mapped registers. The DMA engines can also be configured to receive control messages.

To provide efficient access to relatively small data items separated by a small stride, a DMA engine may be implemented to read a cacheline (or other large slice of memory which can be done in a single lookup) and then to extract the required data elements one at a time.

Latched Instructions

In some embodiments, system 100 can also be configured to latch an instruction and perform the instruction indefinitely. Latching an instruction with at least one source operand being a register marked for receive and a destination register marked for sending turns the processing unit 102 into a data-driven computational node, capable of streaming data through itself.

A number of methods for latching an instruction can be used, including special branch or branches (“branch and latch destination”), the writing of an instruction into a special register (“write instruction”) and the reception of a message specifying that the data payload is an instruction to be latched, among others.

To end execution of a latched instruction, a message command, e.g., EndofStream, can be provided. The EndofStream command can use the receive register field to hold the command while the actual receive register is held in the data payload.

A sender can terminate a stream of messages by sending an EndofStream message to the register receiving the data. The processing unit 102 can continue with the next instruction. The definition of next instruction could be that specified by the return link address, or, if the instruction was latched by any operation specifying its address, by the sequentially next instruction.

Message Broadcast

When building graph-described computational networks such as those supported by messages and latched instructions, the capability to provide a single result to multiple destinations can be implemented by specifying in a single instruction that multiple messages are to be sent. For example, the sending register, which normally contains a destination address and a message tag, can include a bit vector in which each set bit specifies a register which contains such an address. When multiple bits are set, multiple messages will be sent. The number of messages sent concurrently can depend on the implementation. Such a broadcast sending register can use another tag, e.g., a broadcast indicator, in addition to sender; receiver, and message indicators as already described.

An additional message-passing instruction, e.g., markforbroadcast, can be implemented to set up a register for broadcasting. The sending registers indicated by a broadcasting register's bitvector are initialized before being used.

A broadcast register may be used as the destination operand of an instruction, with the instruction being broadcast to the various destinations.

Message Rendezvous

The complement of broadcast is the ability to wait until all or any of multiple messages are received. To provide the wait for all capability, a receive register may be marked as a rendezvous register, requiring a fifth tag, e.g., rendezvous, using another message-passing instruction, e.g., a markforrendezvous instruction.

A rendezvous receive register can be initialized as a bitvector before the signaling threads can signal it. The processing unit 102 can stall until all the bits in the register are zero. A Rendezvous command can be implemented, which can use the message data payload to specify the receive register and the register number.

In other implementations of message encoding, such as one in which the bit specified in the message was specified as a bit vector, it would be possible for the interconnect switches to merge rendezvous messages opportunistically, to reduce interconnect traffic.

The receipt of Rendezvous message can clear the specified bit in the specified receive register.

Simultaneous Multithreading

In further embodiments, message-passing between processing units 102 can operate using processing units 102 with simultaneous multithreading capabilities. Such a processing unit 102 can support multiple contexts simultaneously—that is, be provided with multiple independent register sets. A processing unit 102 which can execute several instructions in a single clock may execute all from a single context, or one from each of several contexts, depending on the thread scheduling mechanisms in use.

In particular, when a processing unit 102 “stalls”, awaiting a message, a multithreading processing unit 102 can execute instructions from another context and can be used for ordinarily-executed instructions as well as latched instructions. Multithreading can also be used in DMA engines with n “channels” that can interleave up to n independent transfers.

In some embodiments, processing unit 102 can include an additional set of registers, such 128 registers rather than 64 registers, to allow processing unit 102 to support two full contexts. The instruction fetch mechanism selects between the contexts according to a pair of status bits, one per context, and modifies the register addresses provided by the instruction operand fields. A sixth bit of register address can be provided internally, and can be set, for example, to 0 for context 0 (accessing registers 0.63) and 1 for context 1 (accessing registers 64.127). This scheme may be extended to any feasible number of contexts and numbers of registers per context.

One way of addressing a register in a specific context executing on a specific processing unit 102 is to use some of the processing unit 102 address bits to specify a context within a processing unit 102—that is, to make contexts look like virtual processing units 102 as far as message-addressing is concerned. For example, using the bottom two bits of the x and y addresses to select such virtual processing units 102 enables 16 contexts per processing unit 102.

Variable-Sized Contexts

Not all contexts need 64 registers; in particular, latched instruction contexts require at most three (without broadcast capability). For greater register efficiency, each context can have a variable number of registers.

Any one of several methods to partition the registers amongst multiple contexts can be used. For example, a maximum number of contexts (say, eight) may be allowed and 8 base registers provided. B0 would provide context 0 with physical registers r0 to whatever the value held in B0 was; context 1 is allocated the register above that to whatever the value in B1 is, and so forth. An 8-bit status register containing a bitvector in which a 1 is set if the corresponding context is ready to execute allows the processing unit 102 to schedule available contexts according to any desired scheduling policy (such as round robin, or priority, or a combination).

Within a context, the registers can be renamed, for example, in context 1, if B1 contains 7 and B2 contains 15, the an instruction mentioning r5 when executed in context 1 would access physical r12−7+5).

If the usage of this system is such that at any time, the contexts are all holding computations which are part of a single program, there protection between contexts is not required. However, if some contexts might be part of another computation, with different mappings and permissions, some protection mechanism can be implemented. For example, tagging each of the B registers with an identifier and arranging for a permission exception on attempted access to another PID's B register.

Messages as Interrupts and Exceptions

A processing system 100 that supports message-passing between processing units 102 may use messages to implement various signals normally architected as exceptions or device interrupts. A context can be dedicated as an “interrupt message” handler, using a conventional receiver register.

Agents as Processing Units

While processing units 102 and DMA engines can act as the active “agents” in the system 100, in some systems on a chip, there may frequently be specialist processors, configurable intelligent devices, and function-block accelerators. Examples of each of these include specialist RISC processors optimized for communications processing; intelligent controller which manage packet queues inside a communications-oriented integrated circuit, and shared mathematical accelerators, for FFTs or discrete cosine transforms.

Specialist processors can be configured to present a message-passing interface to the other agents which allows all interactions between processing units 102 and agents to be done efficiently through the interconnect node 302. Stateful agents can be implemented to support the notion of contexts.

By now it should be apparent that embodiments of systems and methods disclosed herein provide a simple and flexible message-passing architecture that uses new instructions for message sending, receiving, and management in a multi-threading, multi-processor environment. In some embodiments, a computer processing system comprises a plurality of processing units including a plurality of register file entries. Control logic is operable to identify a first register entry as including a message address in response to receiving a first instruction; and identify a second register entry to receive messages in response to receiving a second instruction.

In another aspect, each of a plurality of interconnect nodes can communicate with a respective one of the processing units and to neighboring interconnect nodes and configured with a corresponding interconnect address. Each of the messages can include a destination address. The interconnect nodes can deliver the messages to the respective one of the processing units when the message destination address matches the interconnect node address.

In a further aspect, each of a plurality of interconnect nodes can communicate with a respective one of the processing units and to neighboring interconnect nodes and configured with a corresponding interconnect address. The processing units, the interconnect addresses and the destination addresses can correspond to a Cartesian coordinate system. The interconnect nodes can deliver the messages to a respective one of the processing units when the coordinates of the interconnect node(s) match the coordinates of the destination address. The interconnect nodes can route the messages to another interconnect with a greater y-coordinate when the y-coordinate of the destination addresses is greater than the y-coordinate of the interconnect address. The interconnect nodes can further route the messages to another interconnect with a lesser y-coordinate when the y-coordinate of the destination addresses is less than the y-coordinate of the interconnect address. The interconnect nodes can also route the messages to another interconnect node with a greater x-coordinate when the x-coordinate of the destination addresses is greater than the x-coordinate of the interconnect node address. The interconnect nodes can further route the messages to another interconnect node with a lower x-coordinate when the x-coordinate of the destination addresses is less than the x-coordinate of the interconnect node address.

In another aspect, each of a plurality of messages can include a source address, a destination address, destination coordinates, source coordinates, a receive register specifying field, and message data.

In another aspect, a first buffer between each of the plurality of interconnect nodes and processing units can be configured to store messages to be delivered to the respective one of the processing units. A second buffer between each of the plurality of interconnect nodes and processing units can be configured to store messages to be sent by the respective one of the processing units.

In another aspect, if one of the plurality of interconnect nodes cannot deliver a message to a respective processing unit, the one of the plurality of interconnects can send a new message back to a processing unit that sent the message, wherein the new message includes a source address that is the destination address to which the message could not be delivered, a destination address that is the source address of the message that could not be delivered, and the data in the message; and set a tag value in the new message indicating the message was not delivered.

In a further aspect, a first interconnect node in the plurality of interconnect nodes sending a message can be configured to request buffer space for messages from the first interconnect node from a second interconnect node in the plurality of interconnect nodes receiving the message; and the second interconnect node can respond to the request for buffer space from the first interconnect node by indicating how much of the buffer space has been allocated for the messages from the first interconnect node.

In another aspect, control logic can operate to send an indication of how much buffer space is being used by each of the processing units that has requested buffer space when a predetermined amount of the buffer space is being used.

In another aspect, control logic can operate to clear the first register entry to not include the message address in response to receiving a third instruction; and clear the second register entry to not receive messages in response to receiving a fourth instruction.

In another aspect, the first and second register entries can include a sender indicator, a receiver indicator, and a message indicator. Executing a first instruction sets the sender indicator of a specified register entry; executing a third instruction clears the sender indicator for the specified register entry; executing a second instruction sets the receiver and message indicators for the specified register entry; and executing a fourth instruction clears the receiver indicator for the specified register entry.

In other embodiments, a computer processing system can comprise a plurality of processing units configured to communicate messages among the processing units; and a plurality of registers, wherein the registers are accessible by the processing units and each of the registers includes an indicator of whether the register is a message sender or a message receiver.

In another aspect, the registers can include an indicator of whether a message is available.

In another aspect, a destination of a message can be specified as an address in a register in a sending processing unit.

In a further aspect, the message can be received in a register in a receiving processing unit.

In another aspect, each of a plurality of interconnect nodes can communicate with a respective one of the processing units and is configured with a corresponding interconnect address. The processing units, the interconnect addresses and the destination addresses can correspond to a coordinate system, wherein the interconnects deliver the messages to a respective one of the processing units when coordinates of the interconnect match coordinates of the destination address.

In another aspect, the control logic can perform at least one of the group consisting of send one of the messages to multiple destinations, and utilize multithreading capabilities in the processing units.

In another aspect, the control logic can perform a rendezvous action awaiting messages which will arrive in an unknown order.

In still another aspect, the control logic can send messages between agents other than the plurality of processing units.

In still other embodiments, a method can comprise determining whether a register associated with a processing unit in a computer processing system is marked as a receive register and includes a message; if the register is marked as a receive register and includes a message, a value in the register is available to use as an operand to execute an instruction. Whether a register in the computer processing system is marked as a send register can be determined. If the register is marked as a send register, then a result of an operation is sent over an interconnect to another register specified by a value in the send register. Whether all operands for an instruction are available can be determined, and if all of the operands are available, the instruction can be executed.

In other aspects, the methods can further comprise, if all of the operands are not available, performing at least one of the group consisting of: stalling execution of the instruction, resetting an instruction pointer to point at the stalled instruction, and reattempting to execute the stalled instruction during a subsequent processor cycle; and stalling execution of the instruction until all the operands are available.

The terms “software” and “program,” as used herein, are defined as a sequence of instructions designed for execution on a computer system. Software, a program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 3 and the discussion thereof describe an exemplary information processing architecture, this exemplary architecture is presented merely to provide a useful reference in discussing various aspects of the disclosure. Of course, the description of the architecture has been simplified for purposes of discussion, and it is just one of many different types of appropriate architectures that may be used in accordance with the disclosure. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of system 300, for example, from computer readable media such as memory or other media on other computer systems. Such computer readable media may be permanently, removably or remotely coupled to an information processing system such as system 300. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

Embodiments disclosed here can be implemented in various types of computer processing systems such as a server or a personal computer system. Other embodiments may include different types of computer processing systems. Computer processing systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process. An operating system control operation of the CPU and main memory units as well as application programs.

As used herein, the term “bus” is a system interconnect and is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, a plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

The terms “assert” or “set” and “negate” (or “deassert” or “clear”) are used herein when referring to the rendering of a signal, indicator, status bit, or similar apparatus into its logically true or logically false state, respectively. If the logically true state is a logic level one, the logically false state is a logic level zero. And if the logically true state is a logic level zero, the logically false state is a logic level one.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A computer processing system comprising:
a plurality of processing units including a plurality of register file entries;
control logic operable to:
identify a first register entry as including a message address in response to receiving a first instruction; and
identify a second register entry to receive messages in response to receiving a second instruction.

2. The system of claim 1 further comprising:
a plurality of interconnect nodes, each of the interconnect nodes communicate with a respective one of the processing units and to neighboring interconnect nodes and configured with a corresponding interconnect address; and
each of the messages including a destination address, wherein the interconnect nodes deliver the messages to the respective one of the processing units when the message destination address matches the interconnect node address.

3. The system of claim 1 further comprising:
a plurality of interconnect nodes, each of the interconnect nodes communicate with a respective one of the processing units and to neighboring interconnect nodes and configured with a corresponding interconnect address; and
the processing units, the interconnect addresses and the destination addresses correspond to a Cartesian coordinate system, wherein
the interconnect nodes deliver the messages to a respective one of the processing units when the coordinates of the interconnect match the coordinates of the destination address;
the interconnect nodes route the messages to another interconnect with a greater y-coordinate when the y-coordinate of the destination addresses is greater than the y-coordinate of the interconnect address;
the interconnect nodes route the messages to another interconnect with a lesser y-coordinate when the y-coordinate of the destination addresses is less than the y-coordinate of the interconnect address;
the interconnect nodes route the messages to another interconnect node with a greater x-coordinate when the x-coordinate of the destination addresses is greater than the x-coordinate of the interconnect node address; and
the interconnect nodes route the messages to another interconnect node with a lower x-coordinate when the x-coordinate of the destination addresses is less than the x-coordinate of the interconnect node address.

4. The system of claim 1 further comprising:
each of a plurality of messages includes a source address, a destination address, destination coordinates, source coordinates, a receive register specifying field, and message data.

5. The system of claim 2 further comprising:
a first buffer between each of the plurality of interconnect nodes and processing units configured to store messages to be delivered to the respective one of the processing units; and
a second buffer between each of the plurality of interconnect nodes and processing units configured to store messages to be sent by the respective one of the processing units.

6. The system of claim 1 wherein
if one of the plurality of interconnect nodes cannot deliver a message to a respective processing unit, the one of the plurality of interconnects:
sends a new message back to a processing unit that sent the message, wherein the new message includes a source address that is the destination address to which the message could not be delivered, a destination address that is the source address of the message that could not be delivered, and the data in the message; and
sets a tag value in the new message indicating the message was not delivered.

7. The system of claim 1 further comprising:
a first interconnect node in the plurality of interconnect nodes sending a message is configured to request buffer space for messages from the first interconnect node from a second interconnect node in the plurality of interconnect nodes receiving the message; and
the second interconnect node responds to the request for buffer space from the first interconnect node by indicating how much of the buffer space has been allocated for the messages from the first interconnect node.

8. The system of claim 1 further comprising:
control logic operable to send an indication of how much buffer space is being used by each of the processing units that has requested buffer space when a predetermined amount of the buffer space is being used.

9. The system of claim 1 further comprising:
control logic operable to:
clear the first register entry to not include the message address in response to receiving a third instruction (clearforsend); and
clear the second register entry to not receive messages in response to receiving a fourth instruction (clearforreceive).

10. The system of claim 1 further comprising:
the first and second register entries include a sender indicator, a receiver indicator, and a message indicator, wherein
executing a first instruction sets the sender indicator of a specified register entry;
executing a third instruction clears the sender indicator for the specified register entry;
executing a second instruction sets the receiver and message indicators for the specified register entry; and
executing a fourth instruction clears the receiver indicator for the specified register entry.

11. A computer processing system comprising:
a plurality of processing units configured to communicate messages among the processing units; and
a plurality of registers, wherein the registers are accessible by the processing units and each of the registers includes an indicator of whether the register is a message sender or a message receiver.

12. The computer processing system of claim 11 wherein
registers include an indicator of whether a message is available.

13. The computer processing system of claim 11 further comprising:
a destination of a message is specified as an address in a register in a sending processing unit.

14. The computer processing system of claim 13 further comprising:
the message is received in a register in a receiving processing unit.

15. The computer processing system of claim 11 further comprising:
a plurality of interconnect nodes, each of the interconnect nodes communicate with a respective one of the processing units and is configured with a corresponding interconnect address; and
the processing units, the interconnect addresses and the destination addresses correspond to a coordinate system, wherein the interconnects deliver the messages to a respective one of the processing units when coordinates of the interconnect match coordinates of the destination address.

16. The computer processing system of claim 11, wherein the control logic is further operable to perform at least one of the group consisting of:
send one of the messages to multiple destinations, and
utilize multithreading capabilities in the processing units.

17. The computer processing system of claim 11, wherein the control logic is further operable to:
perform a rendezvous action awaiting messages which will arrive in an unknown order.

18. The computer processing system of claim 11, wherein the control logic is further operable to:
send messages between agents other than the plurality of processing units.

19. A method comprising:
determining whether a register associated with a processing unit in a computer processing system is marked as a receive register and includes a message;
if the register is marked as a receive register and includes a message, a value in the register is available to use as an operand to execute an instruction;
determining whether a register in the computer processing system is marked as a send register;
if the register is marked as a send register, then a result of an operation is sent over an interconnect to another register specified by a value in the send register; and
determining whether all operands for an instruction are available;
if all of the operands are available, executing the instruction.

20. The method of claim 19, further comprising:
if all of the operands are not available, performing at least one of the group consisting of:
stalling execution of the instruction, resetting an instruction pointer to point at the stalled instruction, and reattempting to execute the stalled instruction during a subsequent processor cycle; and
stalling execution of the instruction until all the operands are available.
